(19) United States
(12) Patent Application Publication
(10) Pub. No.: US 2011/0007602 A1
(43) Pub. Date: Jan. 13, 2011

(54) ACCURACY OF A COMPASS PROVIDED WITH A CARRIER STRUCTURE FOR USE IN SUBTERRANEAN SURVEYING

(76) Inventors: Kenneth E. Welker, Nesoya (NO); Roger Ellingsen, Borgen (NO); Rune Toennessen, Oslo (NO)

Correspondence Address: WesternGeco L.L.C.;Kevin McEnaney, IP Dept, 10001 Richmond Avenue, HOUSTON, TX, 77042-4299, US

(21) Appl. No.: 12/500,090

(22) Filed: Jul. 9, 2009

(51) Int. Cl. G01V 1/38; G01V 1/16

(52) U.S. Cl. 367/16; 367/15; 367/14

(57) ABSTRACT

Techniques or mechanisms are provided to improve accuracy in determining headings and/or shapes of carrier structures based on measurements made by one or more compasses that are attached to or provided with the carrier structures. The carrier structures are used to carry survey receivers that detect survey signals affected by a subterranean structure.

### TECHNICAL FIELD

The invention relates generally to improving accuracy of a compass provided on a carrier structure used in subterranean surveying.

### BACKGROUND

Marine survey (seismic survey or electromagnetic (EM) survey) exploration investigates and maps the structure and character of subterranean geological formations underlying a body of water. For large survey areas, a survey spread may have vessels towing multiple streamers through the water, and one or more survey sources (seismic or EM sources) by the same or different vessels. Survey sources are propagated or emitted downwardly into the geological formations. The signals affected by the geological formations are detected by survey receivers attached to the survey streamers, and data representing detected signals is recorded and processed to provide information about the underlying geological features.

Often, one or more compasses are provided on a streamer to aid in determining the heading of the streamer. However, compasses can be adversely affected by magnetic fields that are generated by components of the streamer. As a result, conventionally, compasses are typically mounted externally of the streamer to reduce the amount of magnetic disturbance that each compass experiences from streamer components and electric power fields. However, locating a compass externally of a streamer has various disadvantages, including having to attach the compass to the streamer during deployment of the streamer into the water and having to remove the compass during retrieval of the streamer from the water. Another disadvantage is that batteries have to be used to power the compasses, which leads to having to change, store, and dispose of such batteries. Also, the locations on a streamer where external compasses can be mounted are relatively limited, since compasses have to be located where magnetic coil lines are located (for the purpose of communicating data through the coil lines).

Another issue associated with compasses is that compasses are assumed to be substantially parallel to the streamer that the compasses are mounted in, and it is assumed that the shape of the streamer is substantially straight. “Substantially straight” used in this context means that the spatial frequency of the compasses on the streamer provides enough heading samples to determine changes in streamer shape. Models can be used for fitting measurements to the model unknowns such that changing shapes of the streamer can be determined based on compass readings. However, the assumption that the shape of the streamer is substantially straight is often not correct, such that conventional models that are used do not provide accurate results. A streamer typically includes steering devices to cause steering of the streamer, which deforms the streamer in a deterministic way. The steering devices apply lateral forces on the streamer, such that the streamer shape becomes non-straight. In the presence of such lateral forces applied by streamer steering devices, the models that are conventionally used are not accurate, since the streamer does not have a shape that matches model shapes, and because the streamer shape changes with lateral forces exerted by the steering devices. As a result, in view of the forces applied by steering devices of a streamer, the determination of streamer shapes and streamer headings based on compass readings may be inaccurate.

### SUMMARY

In general, according to an embodiment, techniques or mechanisms are provided to improve accuracy in determining headings and/or shapes of carrier structures based on measurements made by one or more compasses that are attached to or provided with the carrier structures. The carrier structures are used to carry survey receivers that detect survey signals affected by a subterranean structure.

Other or alternative features will become apparent from the following description, from the drawings, and from the claims.

### BRIEF DESCRIPTION OF THE DRAWINGS

FIG. 1 is a schematic plan view of a towed streamer spread that incorporates some embodiments of the invention.

FIG. 2 is a schematic side view of a streamer insert that includes a steering device and compass, in accordance with an embodiment.

FIG. 3 illustrates a compass that is positioned proximate an electrical cable, where the electrical cable has electrical wires having a predefined arrangement for reducing magnetic interference with the compass, in accordance with an embodiment.

FIG. 4 illustrates another cable arrangement positioned proximate to a compass with reduced magnetic interference characteristics in accordance with another embodiment.

FIG. 5 is a schematic diagram that illustrates various forces applied on a streamer section, according to an embodiment.

FIG. 6 is another schematic diagram illustrating various parameters associated with a streamer section.

FIG. 7 shows curved streamer sections between steering devices.

FIG. 8 is a flow diagram of determining bias associated with a compass that is mounted on a streamer that is subject to forces applied by a steering device, according to an embodiment.

FIG. 9 is a block diagram of an exemplary computer that includes processing software to perform tasks according to some embodiments.

### DETAILED DESCRIPTION

In the following description, numerous details are set forth to provide an understanding of the present invention. However, it will be understood by those skilled in the art that the present invention may be practiced without these details and that numerous variations or modifications from the described embodiments are possible.

Generally, according to some embodiments, a compass can be provided as part of a streamer that carries survey receivers. More specifically, the compass can be provided in-line inside the streamer, rather than mounted externally to the streamer. To reduce magnetic interference with the compass, electrical wires in the streamer are arranged such that magnetic fields from the individual electrical wires substantially cancel each other. In addition, the housing surrounding the compass is formed of a non-magnetic material, and the compass is also positioned sufficiently far away from magnetic components in the streamer to reduce magnetic interference. In this manner, both soft and hard magnetic fields are eliminated or reduced, such that the compass provided inside a streamer section (or streamer insert that is provided in-line with the rest of the streamer) can provide accurate compass readings.

Additionally, according to other embodiments, a technique is provided to determine a bias of a compass that results from forces exerted by one or more steering devices in the streamer. A “bias” refers to the difference between the compass heading resulting from forces (including lateral forces) exerted by a steering device and the heading of the compass without the forces exerted by the steering device. By determining the bias of the compass due to forces applied by steering devices on the streamer, more accurate determinations of streamer headings and/or streamer shapes can be determined based on the compass readings.

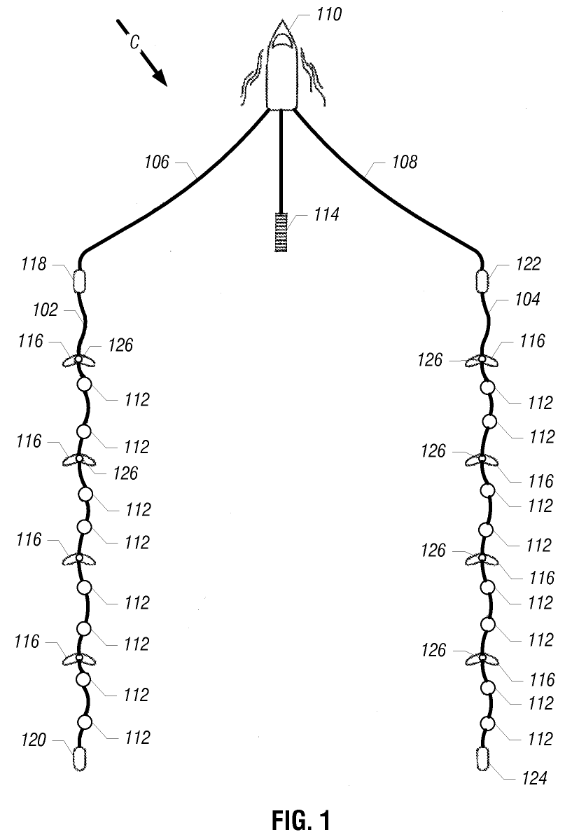

FIG. 1 illustrates an exemplary marine survey arrangement for a marine environment, in which one or more marine streamers 102, 104 are towed by tow cables 106, 108, respectively, attached to a marine vessel 110. Each streamer 102, 104 includes survey receivers 112 (represented as small circles) arranged along the length of each streamer. As further depicted in FIG. 1, a survey source 114 is towed behind the marine vessel 110, where the survey source 114 is activated to generate survey signals that are propagated into a subterranean structure (underneath the water bottom surface). The survey signals affected by the subterranean structure are detected by the survey receivers 112. The survey source 114 can be a seismic source or an electromagnetic (EM) source, and the survey receivers 112 can be seismic or EM receivers.

As depicted in FIG. 1, a water current represented by arrow C tries to force streamers off the path intended by the survey operator. To address this, steering devices 116 are provided along the length of each of the streamers 102 and 104. The steering devices 116 are used to maintain the streamers 102, 104 close to the intended path. However, due to the interaction of the steering devices 116 and the current C, the streamers 102 and 104 may assume a non-straight shape, with some portions between the steering devices 116 bowed. Thus, any determination of the streamer headings and/or streamer shapes that is based on the assumption that each streamer is straight would produce errors.

During periods when other methods of positioning are not available, such as periods when the streamer is without power for acoustics, battery powered compasses can be used to determine the streamer position using the straight streamer assumption as long as there is no steering occurring. Periods when power may not be available include streamer deployment and retrieval, and when power is lost on the streamer due to earth leakage. Since steering is almost always an advantage, some embodiments of this invention introduce a method for using compasses alone or with any other combination of positioning instrumentation, such as GNSS (global navigation satellite system) control points anywhere along the streamer, for streamer positioning even when steering.

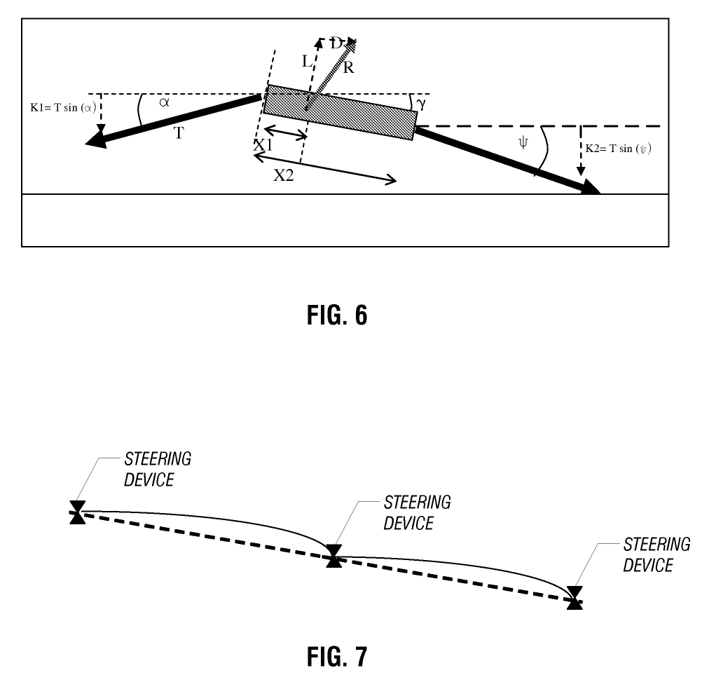

During such periods, the accuracy of the positioning required is not as high as during production. Yet positions have to be determined well enough to avoid streamers colliding. By determining the average heading of the streamer and the streamer take off angles between steering devices, the streamers can be positioned well enough with compasses to allow steering. This is achieved by using a force model to estimate the difference between the steering device heading when misalignment forces are present and the heading (β below) when the misalignment forces are not present. In addition, the shaping of the streamer between steering devices is facilitated by knowing the angle the streamer has going into and out of the curved shape between steering devices (α and ψ in FIG. 6).

Positioning with compasses is improved even further by calibrating the force model during periods when additional information is available, such as acoustically determined coordinates along the streamer and at the steering devices. Parameters of streamer shape can be estimated when acoustically determined points are available to give measured points along the shape. Thus the amount of curvature actually resulting from the steering can be estimated independent of the force or mathematical shape models. In addition, the non misaligned steering device heading can be estimated acoustically and compared to the compass heading to estimate errors in the compass instrument. After these calibration factors have been recorded in software, they can be applied during period when positions are determined only with compasses and the force or mathematical shape, (e.g., hyperbola parameters) models are used.

As further depicted in FIG. 1, buoys (or floats) 118, 120, 122, and 124 are provided at respective leading and trailing ends of each streamer 102, 104. Global positioning system (GPS) receivers can be provided at the buoys 118, 120, 122, and 124 to provide GPS positions of the streamers 102, 104. Other components (not shown) can also be part of the streamer spread depicted in FIG. 1.

In accordance with some embodiments, for improved convenience and efficiency, compasses 126 can be provided in respective steering devices 116. For example, each steering device 116 can have a housing in which a compass 126 can be provided. Alternatively, each compass 126 can be part of a streamer insert that is placed in-line with the streamer 102 or 104, or alternatively, each compass 126 can be part of another streamer section. The compass can be part of an active streamer section containing seismic recording devices, or part of a towing section. In some embodiments, the compass may be mounted external to the streamer, in which the compass is attached to an external part of the streamer by some attachment mechanism.

As noted above, placing a compass 126 in a streamer section or streamer insert can subject the compass to magnetic field interference caused by components and electric power fields in the streamer.

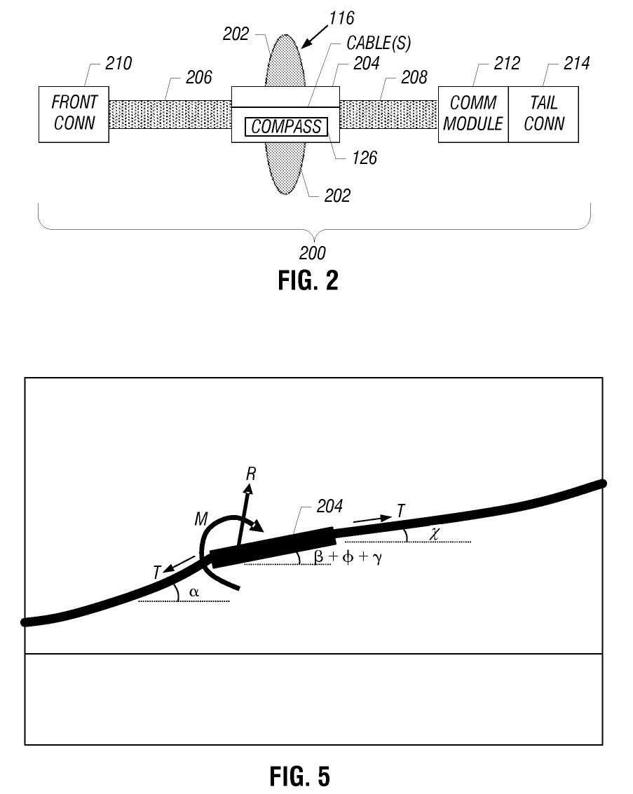

In one example, FIG. 2 shows a compass 126 mounted inside a steering device 116. More specifically, the steering device 116 has a housing 204 that defines an inner chamber in which the compass 126 is provided. The steering device 116 also has steering wings 202 mounted to the housing 204, where the wings 202 are used to provide steering.

Moreover, the housing 204 also contains one or more electrical cables that run from one end of the housing 204 to another end of the housing 204. The electrical cable(s) also run(s) through sections 206 and 208. The section 206 is connected to a front connection assembly 210, and the section 208 is connected to a communications module 212, which in turn is connected to a tail connection assembly 214.

The overall assembly depicted in FIG. 2 is a streamer insert 200, where the front connection and tail connection assemblies 210 and 214 are used to connect to other streamer sections such that the streamer insert 200 is provided in-line with the remainder of the streamer. The communications module 212 is used to perform communications, including communications of commands to control the steering device 116, communications of compass readings, and so forth.

As depicted in FIG. 2, the electrical cable(s) is (are) located proximate the compass 126, and can potentially cause magnetic interference with the compass 126 such that the compass 126 may not provide accurate measurement readings.

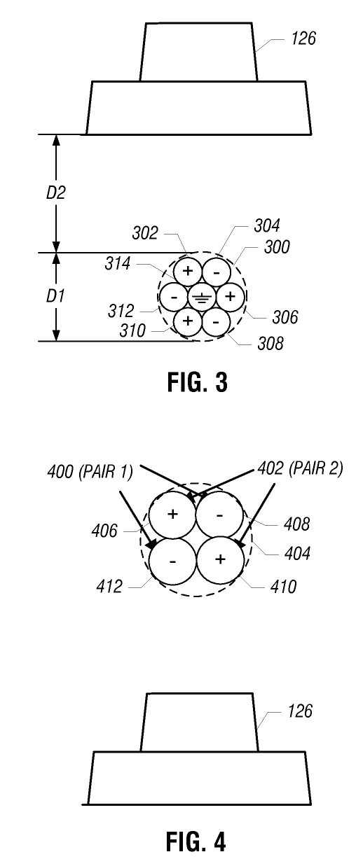

In accordance with some embodiments, to address this issue, each electrical cable that is provided relatively close to the compass 126 has electrical wires that are arranged to provide for reduction or cancellation of magnetic fields. FIG. 3 depicts one example arrangement of electrical wires 302, 304, 306, 308, 310, 312, and 314 in a power cable 300 (which delivers power to components of the streamer). The electrical wire 314 is a ground wire. The “+” symbol and the “−” symbol indicates direction of electrical current flow. The “+” symbol indicates current flow in a first direction through the electrical cable 300, while the “−” symbol indicates current flow in an opposite direction. As depicted in FIG. 3, the “+” and “−” electrical wires are provided in an alternating arrangement such that any “+” electrical wire is between two adjacent “−” electrical wires, and similarly, any “−” electrical wire is between two adjacent “+” electrical wires.

Electrical current flowing through an electrical wire produces a magnetic field surrounding the electrical wire. By positioning two electrical wires of opposite current flows right next to each other, the magnetic fields generated by such electrical wires will substantially cancel each other out. It is noted that there would be portions of the magnetic fields that are not completely cancelled out since there are just a limited number of electrical wires provided in the cable 300.

Improved magnetic field cancellation can be provided by using a cable having an even larger number of electrical wires with the alternating arrangement of “+” and “−” electrical wires. However, the cable 300 having the six alternately arranged “+” and “−” electrical wires provides substantial magnetic field cancellation such that the compass 126 that is positioned a distance D2 from the cable 300 experiences no or very little magnetic field interference from the magnetic fields produced by the electrical wires in the cable 300. In FIG. 3, the electrical cable 300 has a diameter D1.

In one example, the diameter D1 can be 10 millimeters (mm), while D2 is 20 mm. In other examples, other values of D1 and D2 can be used, with D2 set such that the compass 126 is positioned sufficiently far away from the cable 300 such that any remaining or residual magnetic field that has not been cancelled by the alternating arrangement of electrical wires in the cable 300 does not cause magnetic field interference with the compass 126.

FIG. 4 shows another cable 404 that has electrical wires 406, 408, 410, and 412. Note that the cable 300 in FIG. 3 can be the main power cable that is provided in the streamer. On the other hand, the cable 404 can be a network cable that includes two twisted pairs, with a first twisted pair for receive (Rx) data, and a second twisted pair for transmit (Tx) data. For example, Rx data can be provided on a first twisted pair of wires 406, 408, while the Tx data can be provided on a second twisted pair of wires 410, 412.

In addition to communicating Tx and Rx data, power can also be injected into the cable 404 for powering devices connected to the network cable 404 (that do not receive power from the main cable 300 in FIG. 3). Power can be injected, for example, by injecting “−” current in a first pair 400 of electrical wires (408, 412), and by injecting “+” current in a second pair 402 of electrical wires (406, 410). The arrangement of electrical wires 406, 408, 410, and 412 depicted in FIG. 4 is referred to as a quad arrangement.

Magnetic field cancellation provided by the quad arrangement depicted in FIG. 4 is less than the magnetic field cancellation provided by the 6-wire arrangement depicted in FIG. 3. However, since the magnitudes of power current flow in the cable 404 is likely less than the magnitudes of power current flow in the cable 300, the magnetic field cancellation features of the quad arrangement of cable 404 is likely to be acceptable. As further depicted in FIG. 4, the compass 126 is positioned some distance away from the cable 404, such that any residual magnetic field produced by the cable 404 does not cause interference at the compass 126.

In an alternative implementation, instead of providing the compass 126 inside the housing 204 of the steering device 116, the compass 126 can be part of another module that is connected to either the front connection assembly 210 or the tail connection assembly 214. As yet another alternative, compasses can be provided in all three locations (one inside the steering device 116, and one each connected to the front and tail connection assemblies 210 and 214).

To further reduce magnetic interference at the compass 126, the housing 204 that contains the compass 126 is formed of a non-magnetic material. Also, to reduce magnetic interference, the motor of the steering device 116 that drives the wings 202 can be positioned a sufficiently large distance away from the compass 126. A motor contains some amount of magnetic material. When the motor is running, changes to the magnetic field produced by the motor is mainly contained inside the motor.

Also, the wings 202 are also formed mainly of non-magnetic material. Batteries inside the steering device 116 are also positioned a sufficiently large distance away from the compass 126.

Another issue associated with the use of the compass 126 in a streamer is that the streamer can be subjected to forces (including lateral forces) of the steering device 116 that can cause bias in the compass. The “bias” of a compass is the difference between the compass heading resulting from forces applied by the steering device 116, and the compass heading without the forces applied by the steering device. Actual compass headings can be compared with computed compass headings that are computed based on a streamer force model.

The force model receives the following input parameters: tension in the streamer section that contains the compass; side force applied by the steering device 116 on the streamer section; wing angle (which is the angle of the wings 202 of the steering device 116); lift experienced by the wings 202 of the steering device 116; and velocity of the water current (C in FIG. 1). Based on these input parameters, the force model outputs a computed heading. This computed heading can then be compared to the actual compass heading, and the difference between the computed and actual headings constitutes compass bias that can be used to either calibrate the force model or to calibrate the compass. If the force model is assumed to be accurate, then the difference between the computed heading and the actual heading represents a bias of the compass due to forces applied by the steering device 116. This bias can then be used to correct actual readings received from the compass during streamer operation.

However, if the compass heading is known to be accurate (such as due to the compass having been calibrated using another technique), then the difference between the computed heading and the actual heading can be used to calibrate the force model. The calibrated force model can then be used to compute the heading of the streamer section that contains the compass when no steering side forces are applied by a steering device. Further, with a calibrated force model, the streamer shape can be computed, allowing improved positioning of the seismic instruments contained in the streamer section.

In addition, calibration of a compass can be accomplished by using an acoustic mechanism. For example, acoustic devices can be provided ahead and behind the location of the compass, and the acoustic devices are then used to accurately determine the heading of the corresponding streamer section. The acoustic devices that are mounted ahead of and behind the compass location may be acoustic transponders that are part of an acoustic ranging, such as an IRMA (intrinsic range modulated acoustics) system. The acoustic transmitter emits acoustic waves that are received by the streamer seismic hydrophones. The line between each acoustic hydrophone positioned gives a direction that is equal to a tangent point along the streamer. If this tangent point is also the location of a compass, this compass heading determined acoustically can be used to calibrate the compass such that the compass reading from the compass matches the heading determined acoustically.

FIG. 5 illustrates forces that are experienced by the steering device housing 204. Tensions T are applied by the streamer on the steering device housing 204. Also, the steering device housing 204 experiences a moment M due to the wings 202 of the steering device 116. In addition, R represents the fin lift due to lift experienced by the wings 202 of the steering device 116. In FIG. 5, the angle φ is the angle caused by misalignment due to fin moment M, and γ is the angle caused by misalignment due to moment resulting from fin lift (R) and drag due to water friction. The angle α represents the angle between a first streamer section and horizontal, and the angle χ represents the angle between a second streamer section and horizontal. β is the angle the steering device housing would have if there were no misaligning forces, i.e., no bias. Misaligning forces are moments and lateral forces due to the steering device wing angles, or lift. The steering device body heading is the sum of β, which is ideally the compass heading in the non-misaligned steering device body, the misalignment angle due to the moment (φ) and the misalignment angle due to the fin lift (γ): β+φ+γ=compass heading.

β is also the direction of the straight streamer. Any distortion of the streamer such as curvature due to side forces will result in tangent points along the curve that are not parallel with β. But the line between the steering devices is parallel with β despite the curved streamer (FIG. 7) between the steering devices. This allows the computation of β acoustically with an error that is due to the cross line (direction perpendicular to β) acoustic determination error. It is assumed that the error associated with the acoustical determination of β is normally distributed and so will average to zero over many independent determinations: β=arctan(dy/dx).

What follows is the method of estimating the misalignment due to fin lift. In this development, γ is the misalignment due to fin lift. Fin lift (L) is a function of angle of attack which includes current and vessel speed, but will not be further discussed here, The lift (L) has the following relationship to various parameters shown in FIG. 6:

L=K1+K2=T sin(α)+T sin(ψ)

K1·X1=K2·(X1−X2)

γ=α−ψ

The Q-fin body has wing shaft X1 distance from rear and X2 distance from front. To solve for K1 and K2:

K1=K2*(X2−X1)/X1;

XX=(X2−X1)/X1;

Substitute for K1 in terms of L2 into L=K1+K2;

L=K2*XX+K2=K2*(XX+1).

So,

K2=L/(XX+1)

K1=L−L/(XX+1).

Therefore, to solve for α, ψ and γ using K1 and K2:

K1=T sin(α) and K2=T sin(ψ);

γ=α−ψ

where γ is the bias due to fin lift.

Next, the formula for getting the component of misalignment due to moment is calculated:

$$φ = arc sin ( \frac{M}{T \cdot X 2} ) .$$

Combining this information for various values of tension (T), lift (L) and moment (M) gives a table of biases for these conditions. If β is the corrected steering device heading (non-biased, with no misalignment due to fin lift or moment), then

β=Compass Heading−φ−γ+r,

where r is residual compass error due to instrumentation and any other errors.

At different lifts (R) and tensions (T), the biases (difference between computed headings and actual compass headings) can be determined and compiled. The bias values can be stored in a table. The biases stored in this table can be used to either calibrate the compass or calibrate the force model, depending on which is assumed to be less accurate.

Also, a mathematical function fit can be applied to the biases contained in the table for extrapolation at zero lift (in other words, no steering is being applied by the steering device). The zero lift values correspond to values when the streamer is substantially straight. These zero lift values can then be used in performing positioning of the streamer sections based on compass measurements. Effectively, the zero lift values relate to values of a compass that is not subjected to forces applied by steering devices.

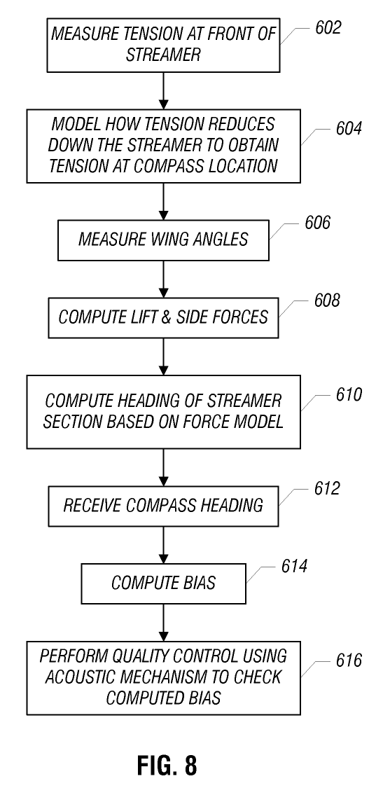

FIG. 8 shows an exemplary procedure for determining bias associated with a compass (whether the compass is provided in-line with the streamer or provided externally of the streamer). The tension at the front of the streamer can be measured (at 602), using tension measurement devices mounted at the front of the streamer. Alternatively, note that tension measurement devices can be mounted elsewhere in the streamer.

Next, a tension model is retrieved regarding how tension is reduced along the length of the streamer from the front of the streamer. Using this tension model, the tension at the location of the compass is obtained (at 604).

The angles of the wings 202 of the steering device 116 are also measured (at 606) using angle measurement devices of the steering device 116. From the wing angles, the lift and side forces can be computed (at 608). Next, the heading of the streamer section is computed (at 610) based on the force model by applying the tension, lift force, side force, and water current velocity (C in FIG. 1) to the force model.

The actual compass reading is also received (at 612). Based on the received compass reading, the bias associated with the compass can be computed (at 614) by determining the difference between the actual compass heading and the computed heading. This bias can be used to correct either the compass or the force model, as noted above. Using the corrected compass headings or outputs of corrected force model, correct headings of sections of a streamer or shapes of the streamer can be determined.

Referring again to FIG. 6, comparing the heading measured by the compass to the angles a and x gives the tangent direction of the streamers at the Q-fin body in global north reference frame. Combining this information with the coordinates of the compass (determined acoustically), boundary conditions for fitting a streamer shape are given between the Q-fin bodies. The shape can be based on fitting a mathematical curve to other acoustically determined points along the streamer or fitting a streamer force model based shape on the acoustically determined points.

In some implementations, quality control can also be performed (at 616) using an acoustic measurement mechanism to check whether the computed bias is accurate. For example, the acoustic measurement mechanism is able to determine the heading of the streamer section in which the compass is located. This heading can be compared with the received compass heading, and the two values can be compared to determine whether it is the compass that requires correction or the force model that requires correction.

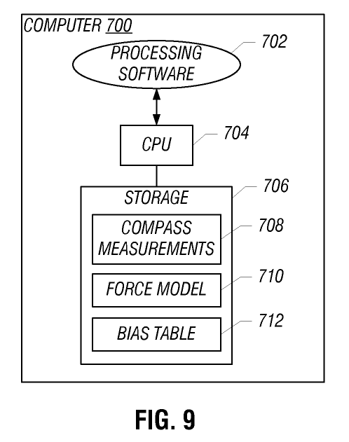

The computations in FIG. 8 can be performed using processing software, such as processing software 702 executable in a computer 700, as shown in FIG. 9. The processing software 702 is executable on one or more central processing units (CPUs) 704, which are connected to storage 706. The storage 706 can be used to store compass measurements 708, a force model 710, and a bias table 712 (that contains biases as a function of tension and/or lift).

Instructions of software described above (including processing software 702 of FIG. 9) are loaded for execution on a processor (such as one or more CPUs 704 in FIG. 9). The processor includes microprocessors, microcontrollers, processor modules or subsystems (including one or more microprocessors or microcontrollers), or other control or computing devices. A “processor” can refer to a single component or to plural components.

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. A module for provision in a carrier structure that has survey sensors used for subterranean surveying, comprising:
a first end portion and a second end portion to mount the module in-line with the carrier structure;
a housing coupled to the first and second end portions;
a compass in the housing; and
an electrical cable having wires arranged to cancel individual magnetic fields of the wires to reduce magnetic interference with the compass.

2. The module of claim 1, wherein the electrical cable is a power cable or a network cable.

3. The module of claim 1, wherein the wires of the electrical cable include first wires in which electrical current flow in a first direction through the electrical cable, and second wires in which electrical current flow in a second, opposite direction through the electrical cable, and wherein the first and second wires are arranged in an alternating arrangement such that each first wire is between two adjacent second wires and each second wire is between two adjacent first wires.

4. The module of claim 3, wherein the electrical cable includes three first wires and three second wires.

5. The module of claim 3, wherein a first pair of the wires is used to communicate transmit data, and a second pair of the wires is used to communicate receive data.

6. The module of claim 1, wherein the housing is formed of a non-magnetic material.

7. The module of claim 1, further comprising:
a steering device having wings to steer the carrier structure, wherein the housing is part of the carrier structure through a body of water.

8. A survey spread for a marine environment, comprising:
a carrier structure having survey sensors to acquire measurement data representing the subterranean structure; and
the module according to claim 1 provided in-line with the carrier structure.

9. The survey spread of claim 8, wherein the module further includes a steering device having wings to steer the carrier structure.

10. A method of determining heading bias of a compass provided with a steered carrier structure, comprising:
receiving a heading measurement made by the compass;
receiving information relating to steering of the carrier structure;
applying the information to a model to compute an estimated heading of the compass; and
determining the heading bias of the compass based on the received heading measurement and the estimated heading.

11. The method of claim 10, wherein the information includes values of parameters that affect steering of the carrier structure, the method further comprising:
determining heading biases for different values of the parameters; and
correlating the heading biases to the different values of the parameters in a data structure.

12. The method of claim 11, wherein the data structure includes a table.

13. The method of claim 10, further comprising:
applying the heading bias to correct a measurement by the compass.

14. The method of claim 10, further comprising:
applying the heading bias to correct the model.

15. The method of claim 10, wherein the information relating to steering of the carrier structure includes tension, moment, and lift.

16. The method of claim 10, further comprising calibrating the compass using an acoustic mechanism.

17. The method of claim 10, wherein receiving the heading measurement made by the compass comprises receiving the heading measurement made by the compass provided in-line with the carrier structure.

18. The method of claim 10, wherein receiving the heading measurement made by the compass comprises receiving the heading measurement made by the compass mounted externally to the carrier structure.

19. A method for use with a carrier structure carrying survey sensors to acquire measurement data representing a subterranean structure, comprising:
using the method of claim 10 to determine a shape of at least one section of the carrier structure.

20. A method for use with a carrier structure carrying survey sensors to acquire measurement data representing a subterranean structure, comprising:
using the method of claim 10 to determine a position of at least one section of the carrier structure.

21. An article comprising at least one computer-readable storage medium containing instructions that when executed cause a computer to:
receive a heading measurement made by a compass provided with a steered carrier structure;
receive information relating to forces experienced by a module including the compass;
apply the information to a model to compute an estimated heading of the compass; and
determine a heading bias of the compass based on the received heading measurement and the estimated heading.

22. The article of claim 21, wherein receiving the information relating to forces experienced by the module comprises receiving the information relating to forces experienced by the module that is part of a steering device.

23. The article of claim 22, wherein the information includes tension, lift, side force, and moment.

24. The article of claim 21, wherein the instructions when executed cause the computer to further:
apply the heading bias to correct a measurement by the compass; or
apply the heading bias to correct the model.
